(19) United States
(12) Patent Application Publication
(10) Pub. No.: US 2010/0151871 A1
(43) Pub. Date: Jun. 17, 2010

(54) Wireless Communication System And Wireless Communication Method

(76) Inventors: Jie Zhang, Beijing (CN); Hua Zhou, Beijing (CN)

Correspondence Address: HANIFY & KING PROFESSIONAL CORPORATION, 1055 Thomas Jefferson Street, NW, Suite 400, WASHINGTON, DC, 20007, US

(21) Appl. No.: 12/529,310

(22) PCT Filed: Aug. 31, 2007
(86) PCT No.: PCT/CN07/70607

§ 371 Date: Mar. 4, 2010

(51) Int. Cl. H04W 72/12; H04B 7/02

(52) U.S. Cl. 455/450; 375/267

(57) ABSTRACT

There is provided a method for scheduling users in a multi user-multi input multi output (MU-MIMO) wireless communication system. The MU-MIMO wireless communication system comprises at least one based station and at least one user equipment, the base station is capable of accommodating plural user equipments by precoding based on a codebook, the method comprising: each of the plural user equipments conducting a channel estimation based on a pilot signal transmitted from the base station, to obtain a channel information; determining, based on the channel information, a codeword that results in the maximum signal-noise-ratio (SNR), and a channel quality indictor (CQI) value corresponding to the codeword; and feeding back the codeword and the CQI value to the base station, the base station setting up an active user set that includes at least one user allowed of downlink transmission based on the codewords and the CQI values fed back from the user equipments, so that a predetermined performance metric of the system is maximized.

### TECHNICAL FIELD

This invention generally relates to wireless communication, and more particularly, to user scheduling in a MU-MIMO (multi-user multiple input multiple output) wireless communication system.

### BACKGROUND OF THE INVENTION

MU-MIMO (Multiple User-Multiple Input Multiple Output), which is a communication technology enabling multiple terminals each having one or plural antennas to communicate simultaneously with one control station having plural antennas, has been a great enabler for high efficiency data transmission in cellular wireless network. There have been many proposals on how to support multi-user transmission on the same MIMO channel [documents 1˜6].

Basically, in terms of channel state information availability at the transmitter, these proposals can be categorized into two classes, one is called “codebook based”, which don't need full channel information at the transmitter, but only the quantized channel vector (in the form of channel vector index feedback), the other one is called “non-codebook based”, which needs full channel information at the transmitter, by means of possible uplink sounding method. The present invention is directed to codebook based MU-MIMO.

Currently, in 3GPP LTE (3^{rd} Generation Partnership Project, Long Term Evolution) there are two main kinds of proposals for MU-MIMO under the codebook based scheme: unitary precoding (document 3) and non-unitary precoding (document 1). “Unitary” means the codeword in the same DFT matrix are orthogonal; on the other hand, “non-unitary” means that the codeword in the codebook are not orthogonal.

FIG. 1 shows schematically the related art MU-MIMO precoding scheme. As shown in FIG. 1, the base station schedules users and determines the data rate based on the CQI (Channel Quality Indictor) and PVI (Precoding Vector Index) fed back from the user equipments, then the data for each scheduled user can be channel-coded and modulated, and precoded with some weight vector based on PVI, combined with data for other users, and then transformed by IFFT and added by Cyclic Prefix (CP) in case of OFDM scheme, at last transmitted on each transmitter antenna. Here, the IFFT and CP unit can be omitted in case of multiplexing schemes other than OFDM.

In FIG. 1, each user equipment (mobile station) is shown to have a single receiver antenna, however, the user equipments can have plural receiver antennas. The data received by the receiver antenna undergoes CP removal and FFT transform, then user-specific data is extracted by receiver combining. Note that the CP removal and FFT transform units can be omitted in case of multiplexing scheme other than OFDM. At the same time, channel estimation is performed based on common pilot or dedicated pilot, then CQI is computed and PVI is determined before feedback to base station for the next schedule slot.

FIG. 2 shows an example of precoding scheme for 2-user 2-Tx MU-MIMO. As shown in FIG. 2, the data for user 1 (d₁) and the data for user 2 (d₂) are weighted by vectors [w₁₁, w₁₂], and [w₂₁, w₂₂], respectively, and are added together on each transmitter. In this example, precoding vectors [w₁₁, w₁₂], and [w₂₁, w₂₂] are selected from one common codebook known to both base station and user equipments. At each receiver, the data can be extracted by utilizing the interference avoidance nature of precoding codebook. In unitary precoding, the codebook with orthogonal vectors can be constructed by some basic math rule, for example, the top n_{T} rows of DFT matrix with the size N (=2^{B}) can be such kind of codebook, as indicated by the following equation,

$${f}_{n} ( l ) = exp ( - \frac{j2π nl}{N} ) , l = 0 , … , {n}_{T} = 0 ; n = 0 , … , N - 1 \qquad ( 1 )$$

wherein, fₙ(1) is the 1-th element of the n-th vector, n_{T} is the number of transmitting antennas, and N is the size of the codebook, j is the imaginary number. In unitary precoding, the codebook is unitary matrix-based, i.e., N vectors compose P=N/M unitary matrices, where M is the number of transmitting streams, and the p-th unitary matrix is denoted as Fp=[fₚ, f_{p+P}, f_{p+2P}, . . . ] (p=0, . . . ,P−1). The same unitary matrix-based codebook is utilized at both the Node B (base station) and UE side in unitary precoding.

In unitary precoding, the CQI can be computed as:

$${CQI}_{k} = {arg max}_{i , j ∈ [ 1 , … P ]} ( \frac{{\vert {H}_{k} {F}_{i} \vert}^{2}}{{σ}^{2} + {\sum }_{j \neq i} {\vert {H}_{k} {F}_{j} \vert}^{2}} ) \qquad ( 2 )$$

wherein H is a channel matrix, F is a weighting matrix, σ² is a noise power, and k is an user index.

Note that the CQI computation takes into account all interference from other precoding vector except its own. In this case, the CQI is heavily underestimated, so that the throughput of the system is not exploited sufficiently.

On the other hand, in non-unitary precoding, the CQI is computed as:

$${CQI}_{k} = {arg max}_{i , j ∈ [ 1 , … P ] , {\vert {F}_{i} {F}_{j} \vert}^{2} < {P}_{thrd}} ( \frac{{\vert {H}_{k} {F}_{i} \vert}^{2}}{{σ}^{2} + {\vert {H}_{k} {F}_{j} \vert}^{2}} ) \qquad ( 3 )$$

here, F is a weighting matrix from a non-orthogonal codebook. Although the CQI computation considers the interference from other streams, but it cannot be guaranteed the user that the BS selects will really use the precoding index determined in the CQI computation. Therefore, the CQI computation will also possibly mismatch with the realistic capacity.

Moreover, the simultaneous transmission of several subscriber stations introduces the interference between users, i.e., multi-user interference which deteriorates the systems performance. As the difference between the codebook and practical channel direction is obvious in some cases even if the best codebook is selected, the multi-user interference can not be suppressed completely.
Document 1: Part 16: Air Interface for Fixed Broadband Wireless Access Systems, IEEE P802.16 (Draft March 2007), Revision of IEEE Std 802.16-2004, as amended by IEEE Std 802.16f-2005 and IEEE 802.16e-2005.
Document 2: 3GPP R1-072422, NTT DoCoMo, “Investigation on precoding scheme for MU-MIMO in E-UTRA downlink”.
Document 3: 3GPP, R1-060335, Samsung, “Downlink MIMO for EUTRA”.
Document 4: 3GPP, R1-060495, Huawei, “Precoded MIMO concept with system simulation results in macrocells”.
Document 5: 3GPP, R1-062483, Philips, “Comparison between MU-MIMO codebook-based channel reporting techniques for LTE downlink”.
Document 6: 3GPP, R1-071510, Freescale Semicoductor Inc, “Details of zero-forcing MU-MIMO for DL EUTRA”.

### SUMMARY OF THE INVENTION

Accordingly, the present invention is directed to a method for scheduling user in a MU-MIMO system that substantially obviates one or more of the problems due to limitations and disadvantages of the related art.

It is an object of the present invention to minimize multi-user interference in MU_MINO system.

It is another object of the present invention to maximize the throughput of MU-MIMO downlink transmission.

In order to achieve the above objects, in an aspect of the invention, there is provided a method for scheduling users in a multi user-multi input multi output (MU-MIMO) wireless communication system, wherein the MU-MIMO wireless communication system comprises at least one based station and at least one user equipment, the base station is capable of accommodating plural user equipments by precoding based on a codebook, the method comprising:

each of the plural user equipments

conducting a channel estimation based on a pilot signal transmitted from the base station, to obtain a channel information;

determining, based on the channel information, a codeword that results in the maximum signal-noise-ratio (SNR), and a channel quality indictor (CQI) value corresponding to the codeword; and

feeding back the codeword and the CQI value to the base station, and the base station

setting up an active user set that includes at least one user allowed of downlink transmission based on the codewords and the CQI values fed back from the user equipments, so that a predetermined performance metric of the system is maximized.

In an aspect of the invention, there is provided a multi user-multi input multi output (MU-MIMO) wireless communication system, wherein the MU-MIMO wireless communication system comprises at least one based station and at least one user equipment, the base station is capable of accommodating plural user equipments by precoding based on a codebook, wherein,

each of the plural user equipments comprises:

a channel estimation unit configured to conduct a channel estimation based on a pilot signal transmitted from the base station, to obtain a channel information;

a determination unit configured to determine, based on the channel information, a codeword that results in the maximum signal-noise-ratio (SNR), and a channel quality indictor (CQI) value corresponding to the PVI; and

a transmission unit configured to feed back the codeword and the CQI value to the base station, and

the base station comprises:

a schedule unit configured to set up an active user set that includes at least one user allowed of downlink transmission based on the codewords and the CQI values fed back from the user equipments, so that a predetermined performance metric of the system is maximized.

In another aspect of the invention, there is provided a base station in a multi user-multi input multi output (MU-MIMO) wireless communication system, wherein the base station is capable of accommodating plural user equipments by precoding based on codebook, each of the plural user equipments comprises a channel estimation unit configured to conduct a channel estimation based on a pilot signal transmitted from the base station, to obtain a channel information; a determination unit configured to determine, based on the channel information, a codeword that results in the maximum signal-noise-ratio (SNR), and a channel quality indictor (CQI) value corresponding to the codeword; and a feedback unit configured to feed back the codeword and the CQI value to the base station,

the base station comprises:

a schedule unit configured to set up an active user set that includes at least one user allowed of downlink transmission, based on the codewords and the CQI values fed back from the user equipments, so that a predetermined performance metric of the system is the maximum.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention. In which,

FIG. 1 shows schematically the related art MU-MIMO precoding scheme;

FIG. 2 shows an example of precoding scheme for 2-user 2-Tx MU-MIMO;

FIG. 3 is a schematic block diagram of the user equipment of the first embodiment;

FIG. 4 is a schematic block diagram of the feedback unit;

FIG. 5 is a schematic block diagram of the base station of the first embodiment;

FIG. 6 is a flowchart of the schedule process of the schedule unit of the first embodiment;

FIG. 7 is a conceptual view illustrating evaluation of orthogonality among codewords;

FIG. 8 is a flowchart of the schedule process of the schedule unit of the second embodiment.

### DETAILED DESCRIPTION OF THE INVENTION

The present invention now will be described in detail with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

### Embodiment 1

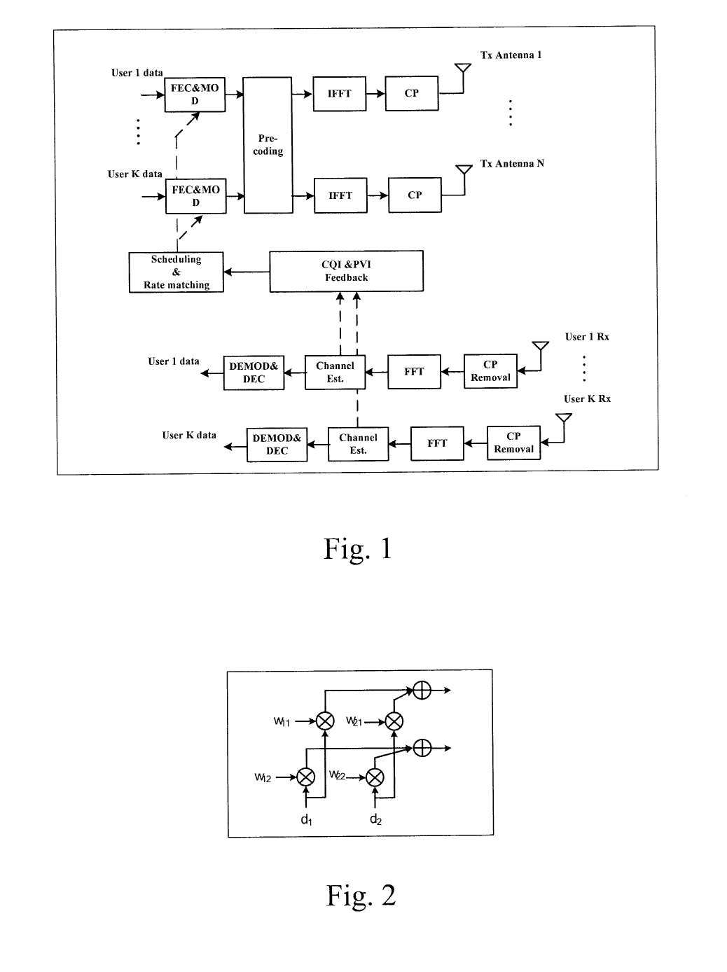

The general configuration of the MU-MIMO wireless communication system of the first embodiment is substantially the same as that shown in FIG. 1. In other words, the MU-MIMO wireless communication system of the first embodiment is applied in OFDM (Orthogonal Frequency Division Multiplexing) system. Reference will be made to FIG. 1 in the following description. However, as will be apparent from the following description, the present invention is not limited to OFDM system, and can be applied to any multiplexing schemes other than OFDM.

As shown in FIG. 1, the MIMO wireless communication system of the first embodiment comprises at least one base station (only one shown in FIG. 1) and at least one user equipment, the base station is equipped with N transmitting antennas, and is capable of accommodating plural user equipments by precoding based on a codebook. The base station schedule users and determine the data rate based on the feedback CQI (Channel Quality Indictor) and PVI (Precoding Vector Index), then the data for each scheduled user can be channel coded and modulated, and precoded with weight vectors, combined with other user data, and then transformed by IFFT and added by Cyclic Prefix (CP), at last transmitted through each transmitting antenna.

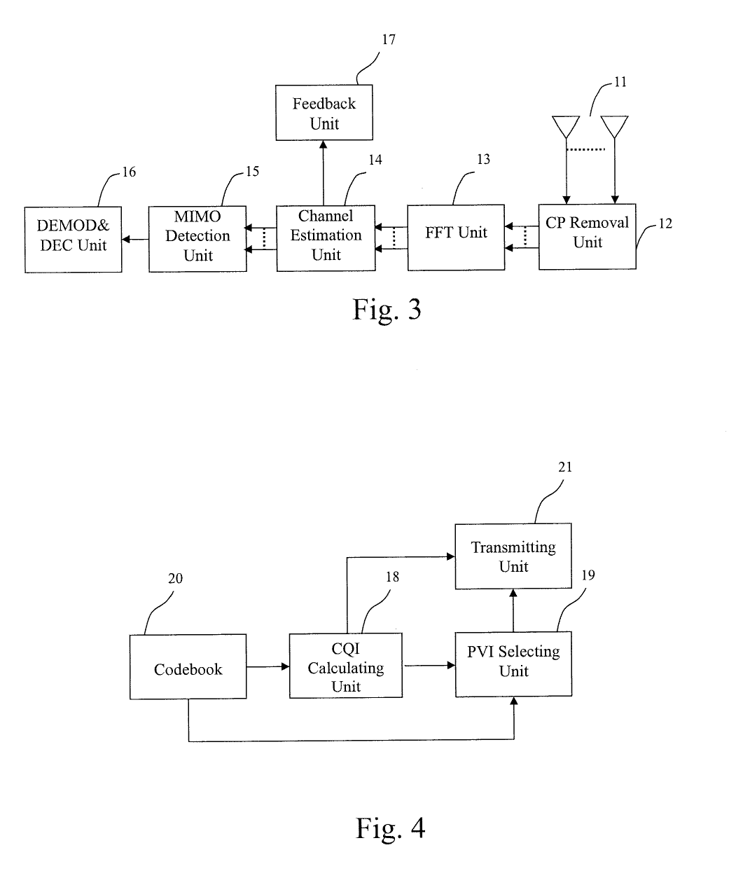

FIG. 3 is a schematic block diagram of the user equipment of the first embodiment. As shown in FIG. 3, the user equipment comprises at least one receiving antenna 11, a CP (cyclic prefix) removal unit 12, a FFT (Fast Fourier Transform) unit 13, a channel estimation unit 14, a MINO detection unit 15, a DEMOD&DEC (demodulating and decoding) unit 16, and a feedback unit 17.

The receiving antennas 11 receive a plurality of multiplexed data streams. The CP removal unit 12 removes a CP portion from the data streams received by the antennas 11. The FFT unit 13 performs a FFT process on the CP-removed data streams. The channel estimation unit 14 estimates the channels (streams) using pilot components included in the data streams, and provides the estimated channel matrix to the feedback unit 17. Using the estimated channel matrix, the MIMO detection unit 15 detects data streams transferred from different receive antennas and processed by the FFT unit 13. The DEMOD&DEC unit 16 demodulates the data processed by the MIMO detection unit 15 and decodes the demodulated data into user data.

FIG. 4 is a schematic block diagram of the feedback unit 17 shown in FIG. 3. The feedback unit 17 includes a CQI calculating unit 18, a PVI determination unit 19, a codebook 20, and a transmitting unit 21.

The codebook 20 contains codewords for precoding data streams transmitted from a control station (e.g. a base station). The CQI calculating unit 18 generates a channel quality indictor (CQI) based on the estimated channel matrix information. In this embodiment, the CQI calculating unit 18 calculates post-processing SINRs (signal-to-interference & noise ratio) for each data stream as the CQI. The post-processing SINRs is computed by assuming that there are precoding weighting at the control station, and also prescribed MIMO decoding method at the HE side, such as ZF (Zero-Forcing) or MMSE (Minimal Mean Squire Error), or other methods. The precoding weighting vector is determined by the PVI determination unit 19. The PVI determination unit 19 selects the appropriate precoding codeword from the codebook 20 to maximize predetermined performance metric, such as the post-processing SINRs for each data stream, which can be based on sum-rate maximization, or BLER minimization, or other criterion. This PVI corresponds to one codeword in the codebook 20 by predetermined mapping rule which is known to both control station and user equipments.

Further, PVIs of the determined codewords and the CQIs are fed back to the base station by the transmitting unit 21.

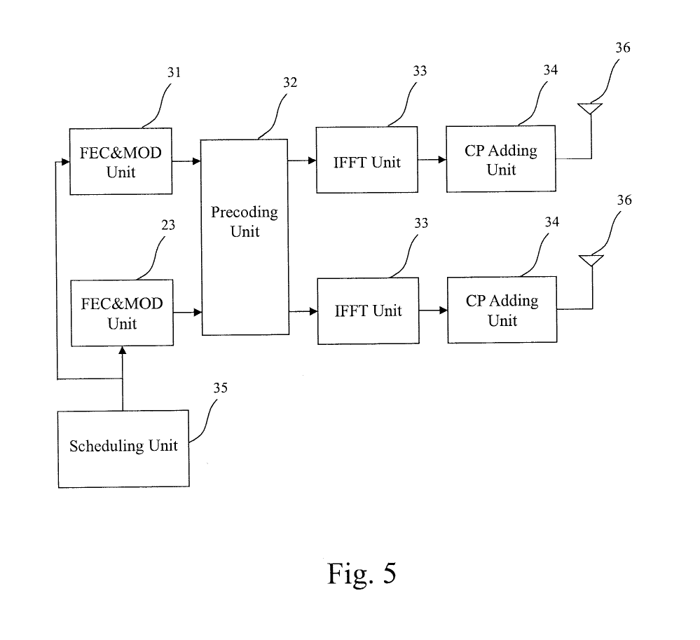

FIG. 5 is a schematic block diagram of the base station in the first embodiment. As shown in FIG. 5, the base station comprises a plurality of transmitting antennas 36, and an FEC&Mod unit 31 (FEC: “Forward Error Correction”, a kind of channel coding), an IFFT (Inverse Fast Fourier Transform) unit 33 and a CP adding unit 34, number of which corresponds to the number of the transmitting antennas 31, and a precoding unit 32, a scheduling unit 35.

The scheduling unit 35 is equipped with a codebook that contains the same contents as that in all user equipments, group users having the matching codeword, and schedules and determines the data rate based on the CQI (Channel Quality Indictor) and PVI (Precoding Vector Index) fed back from the user equipments. The FEC&Mod unit 31 performs channel-coding and modulation on the data for each user. The precoding unit 32 precodes the user data with the determined precoding vectors, and combines data from all users. The IFFT unit 33 performs IFFT transformation on the precoded data, and the CP adding unit 34 adds Cyclic Prefix (CP) to the IFFT-transformed data, then the transmitting antennas 31 transmit the data.

Now a detailed description will be made to the schedule process of the MU-MIMO communication system of the first embodiment.

At first, the channel estimation unit 14 of each user equipment (sometimes referred to as “user” hereinafter) estimates its own channel state information, then the feedback unit 17 selects the best precoding vector in the N^{b}-bit set of codebook according to maximization of receive signal-to-noise ratio (SNR) and calculates the channel quality indicator (CQI) value.

Specifically, assuming the codebook set known to both Node B (base station) and each user equipment is denoted by

$$S = [ {c}_{0} , {c}_{1} , … , {c}_{{2}^{{N}^{b}}} ] ,$$

and the channel state information from base station to user k is denoted by Hₖ ∈ C^{M×K}^{ₖ} whose element is Rayleigh fading with unit covariance and independent with each other. Further, it is assumed that each user estimates its channel state information Hₖ accurately. For convenience, the noise power at all terminals is assumed to be the same, say, σₙ². The feedback unit 17 of user k selects the best codebook vector according to the following maximum SNR criteria,

$${w}_{k} = {arg max}_{{c}_{l} ∈ S} ( {‖ {H}_{k}^{H} {c}_{l} ‖}_{2}^{2} ) \qquad ( 4 )$$

where “(•)^{H}” denotes conjugate operation. CQI value is obtained by

CQIₖ=∥Hₖ^{H}wₖ∥₂² (5)

Then, the users feedback the determined precoding vector index and CQI value to base station by transmitting unit 21 via dedicated feedback uplink channel.

The base station demodulates the information on precoding vector indices and CQIs from all users, then determines the active user set, i.e., the set contains the user indices which are allowed of downlink data transmission.

The determination of active user set is according to greedy algorithm and is detailed as following steps.

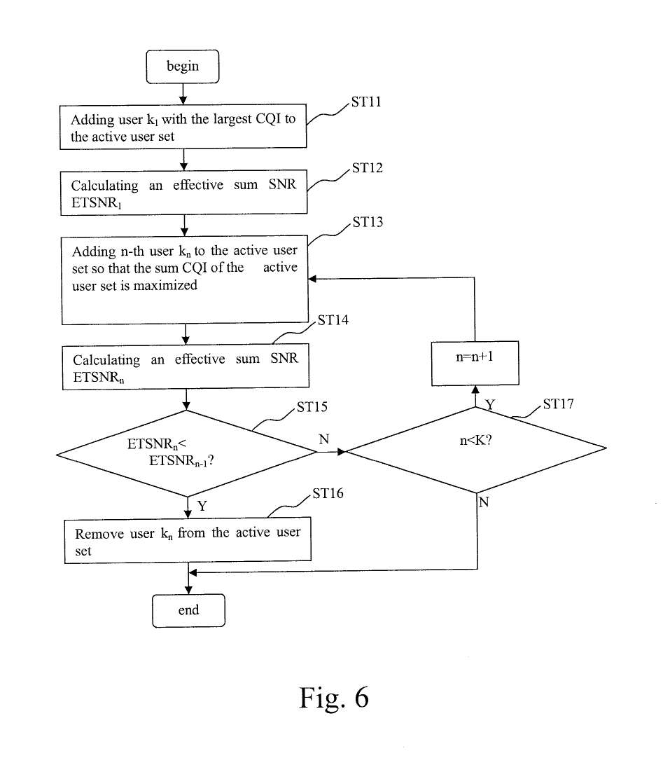

FIG. 6 shows a flowchart of the schedule process of the first embodiment.

As shown in FIG. 6, in ST11, the schedule unit 35 determines the largest CQI among the CQIs feedback from the user equipments, and adds the corresponding user equipment k₁ to the active user set.

In ST12, the schedule unit 35 calculates an effective SNR of the active user set, which is denoted as ESNR₁.

In ST13, the schedule unit 35 adds a n-th (n>1) user kₙ to the active user set so that the sum CQI of the active user set is the maximum.

In ST14, the schedule unit 35 calculates an effective SNR of the active user set, which is denoted as ESNRₙ.

In ST15, the schedule unit 35 judges whether the effective SNR of the active user set containing n users (ESNRn) is smaller than the effective SNR of the active user set containing n−1 users (ESNRn−1).

If it is judged ESNRn<ESNRn−1, an active user set including n−1 users is preferable to an active user set including n users, the process enters into ST16, the schedule unit 35 remove the newly added user kₙ from the active user set, so that the active user set includes user k₁˜kₙ₋₁. Then the schedule process of the schedule unit 35 is end.

On the other hand, if it is judged in ST15 that ESNRₙ is not smaller than ESNRₙ₋₁, the process proceeds to ST17. In ST17, it is judged whether the number of users included in the active user set equals to K (the number of antennas of the base station, that is, the number of users allowed of simultaneous transmission). If it is judged that n<K, n is incremented, and the process is returned to ST13 to repeat the following steps. However, if it is judged in ST17 n is not smaller than K, in other words, n=K, the schedule process is ended, with the active user set including users 1˜n.

Now a specific example will be provided.

First, the schedule unit 35 chooses the first user k₁ with the largest CQI value for downlink transmission, i.e.,

$${k}_{1} = arg {max}_{j = 1 , … , K} ( {CQI}_{j} * ‖ {w}_{j} ‖ ) \qquad ( 6 )$$

the effective ESNR is denoted as:

ESNR₁=P·CQI₁ (7)

the sum capacity C₁ of the active user set including only the first user k₁ is calculated as:

C₁=log 2(1+P*CQIₖ_{₁}/σₙ²) (8)

where P is the total transmits power, and σₙ is the noise power.

Next, the schedule unit 35 selects a second user k₂ based on the CQI values of each user, so that the sum CQI of the active user set including users k₁ and k₂ is the maximum, as indicated by the following formula,

$${k}_{2} = arg {max}_{j = 1 , … , K} ( ( {CQI}_{{k}_{1}} + {CQI}_{j} ) \cdot ‖ {w}_{{k}_{1}} ‖ \cdot ‖ {P}_{{w}_{{k}_{1}}}^{⊥} {w}_{j} ‖ ) \qquad ( 6 )$$

where

$${P}_{{w}_{{k}_{1}}}^{⊥}$$

is the projection matrix onto the null space spanned by the columns orthogonal to wₖ_{₁}, i.e.,

$${P}_{{w}_{{k}_{1}}}^{⊥} = I - {w}_{{k}_{1}} {w}_{{k}_{1}}^{H} \qquad ( 10 )$$

I is identity matrix with appropriate dimension.

There is no power allocation between these two users, and the effective sum SNR is denoted by,

$${ESNR}_{2} = P / 2 \cdot ( {CQI}_{{k}_{1}} + {CQI}_{{k}_{2}} ) \cdot ‖ {w}_{{k}_{1}} ‖ \cdot ‖ {P}_{{w}_{{k}_{1}}}^{⊥} {w}_{{k}_{2}} ‖ \qquad ( 11 )$$

the corresponding sum capacity of the active user set including these two users (k₁, k₂) is calculates as,

$${C}_{2} = log 2 ( 1 + \frac{P / 2 * {‖ {H}_{{k}_{1}}^{H} {w}_{{k}_{1}} ‖}^{4}}{{σ}_{n}^{2} {‖ {H}_{{k}_{1}}^{H} {w}_{{k}_{1}} ‖}^{2} + P / 2 {‖ {( {H}_{{k}_{1}}^{H} {w}_{{k}_{1}} )}^{H} ( {H}_{{k}_{1}}^{H} {w}_{{k}_{2}} ) ‖}^{2}} ) + log 2 ( 1 + \frac{P / 2 * {‖ {H}_{{k}_{2}}^{H} {w}_{{k}_{2}} ‖}^{4}}{{σ}_{n}^{2} {‖ {H}_{{k}_{2}}^{H} {w}_{{k}_{2}} ‖}^{2} + P / 2 {‖ {( {H}_{{k}_{2}}^{H} {w}_{{k}_{2}} )}^{H} ( {H}_{{k}_{2}}^{H} {w}_{{k}_{1}} ) ‖}^{2}} ) \qquad ( 12 )$$

The schedule unit 35 judges whether ESNR₂ is smaller than ESNR₁. If ESNR₂ is smaller than ESNR₁, the schedule unit 35 determines that the scheduling process is competed, and the active user set contains only user k₁. On the other hand, if ESNR₂ is not smaller than ESNR₁, and K>2, the schedule unit 35 proceeds to selection of the third user. Similarly, the schedule unit selects the third user k₃ for downlink transmission in a manner that sum CQI of the active user set including users k₁, k₂ and k₃ is maximized, as indicated by the following formula:

$${k}_{3} = arg {max}_{j = 1 , … , K} ( ( {CQI}_{{k}_{1}} + {CQI}_{{k}_{2} +} {CQI}_{j} ) \cdot ‖ {w}_{{k}_{1}} ‖ \cdot ‖ {P}_{{w}_{{k}_{1}}}^{⊥} {w}_{{k}_{2}} ‖ \cdot ‖ {P}_{[ {w}_{{k}_{1}} , {w}_{k2} ]}^{⊥} {w}_{j} ‖ ) \qquad ( 13 )$$

where

$${P}_{[ {w}_{{k}_{1}} , {w}_{{k}_{2}} ]}^{⊥}$$

is the orthogonal space tot he column space spanned by [wₖ_{₁},wₖ_{₂}]. When the third user k₃ is deter wined, the effective sum SNR can be expressed by,

$${ESNR}_{3} = P / 3 \cdot ( {CQI}_{{k}_{1}} + {CQI}_{{k}_{2}} + {CQI}_{{k}_{3}} ) \cdot ‖ {w}_{{k}_{1}} ‖ \cdot ‖ {P}_{{w}_{{k}_{1}}}^{⊥} {w}_{{k}_{2}} ‖ \cdot ‖ {P}_{[ {w}_{{k}_{1}} , {w}_{k2} ]}^{⊥} {w}_{{k}_{3}} ‖ \qquad ( 14 )$$

the corresponding sum capacity of these three users is given by,

$${C}_{3} = log 2 ( 1 + \frac{P / 3 * {‖ {H}_{{k}_{1}}^{H} {w}_{{k}_{1}} ‖}^{4}}{\begin{matrix}{σ}_{n}^{2} {‖ {H}_{{k}_{1}}^{H} {w}_{{k}_{1}} ‖}^{2} + P / 3 {‖ {( {H}_{{k}_{1}}^{H} {w}_{{k}_{1}} )}^{H} ( {H}_{{k}_{1}}^{H} {w}_{{k}_{2}} ) ‖}^{2} + \\ P / 3 {‖ {( {H}_{{k}_{1}}^{H} {w}_{{k}_{1}} )}^{H} ( {H}_{{k}_{1}}^{H} {w}_{{k}_{3}} ) ‖}^{2}\end{matrix}} ) + log 2 ( 1 + \frac{P / 3 * {‖ {H}_{{k}_{2}}^{H} {w}_{{k}_{2}} ‖}^{4}}{\begin{matrix}{σ}_{n}^{2} {‖ {H}_{{k}_{2}}^{H} {w}_{{k}_{2}} ‖}^{2} + P / 3 {‖ {( {H}_{{k}_{2}}^{H} {w}_{{k}_{2}} )}^{H} ( {H}_{{k}_{2}}^{H} {w}_{{k}_{1}} ) ‖}^{2} + \\ P / 3 {‖ {( {H}_{{k}_{2}}^{H} {w}_{{k}_{2}} )}^{H} ( {H}_{{k}_{2}}^{H} {w}_{{k}_{3}} ) ‖}^{2}\end{matrix}} ) log 2 ( 1 + \frac{P / 3 * {‖ {H}_{{k}_{2}}^{H} {w}_{{k}_{2}} ‖}^{4}}{\begin{matrix}{σ}_{n}^{2} {‖ {H}_{{k}_{3}}^{H} {w}_{{k}_{3}} ‖}^{2} + P / 3 {‖ {( {H}_{{k}_{3}}^{H} {w}_{{k}_{3}} )}^{H} ( {H}_{{k}_{3}}^{H} {w}_{{k}_{1}} ) ‖}^{2} + \\ P / 3 {‖ {( {H}_{{k}_{3}}^{H} {w}_{{k}_{3}} )}^{H} ( {H}_{{k}_{3}}^{H} {w}_{{k}_{2}} ) ‖}^{2}\end{matrix}} ) \qquad ( 15 )$$

Then, the schedule unit 35 judges whether ESNR₃ is smaller than ESNR₂. If ESNR₃ is smaller than ESNR₂, the schedule unit 35 determines that the scheduling process is competed, and the active user set contains only users k₁ and k₂. On the other hand, if ESNR₃ is not smaller than ESNR₂, and K>3, the schedule unit 35 proceeds to selection of the 4th user.

As described above, in general sense, the Q-th user is selected by,

$${k}_{Q} = arg {max}_{j = 1 , … , K} ( ( {\sum }_{q = 1}^{Q - 1} {CQI}_{{k}_{q}} + {CQI}_{j} ) \cdot Volume ( Q ) ) \qquad ( 16 )$$

here, Volume(Q) denotes the volume of the super-polyhedron constituted by wₖ_{₁}, wₖ_{₂}, . . . ,w_{f}. Then the effective sum SNR is given by,

$${ESNR}_{Q} = P / Q \cdot {\sum }_{q = 1}^{Q} {CQI}_{{k}_{q}} \cdot Volume ( Q ) \qquad ( 17 )$$

After the Q-th user is determined, it is judged whether ESNR_{Q}<ESNR_{Q-1}, occurs, if it is judged ESNR_{Q}<ESNR_{Q-1}, the schedule process is ended and the active user set includes users k₁˜k_{Q-1}, the sum capacity can be calculated accordingly. On the other hand, if ESNR_{Q}≧ESNR_{Q-1} and Q<K, it is proceeded to the selection of the (Q+1)-th user.

It is to be noted that in computation of sum CQI of the active user set, there is introduced a term Volume(Q), which is metric of interferences among users. Now this term will be explained in detail.

It could be understood that if codewords of all users in the active user set are orthogonal to each other, users in the active user set would not exert interference to each other. Therefore it is preferable that codewords of all users in the active user set are orthogonal to each other.

In the present invention, in computing the sum CQI, a term reflecting the orthogonality among codewords, i.e., Volume(Q), is multiplied to the sum CQI of the active user set.

The orthogonality among codewords can be represented by volume of a polyhedron constituted by vectors of the codewords.

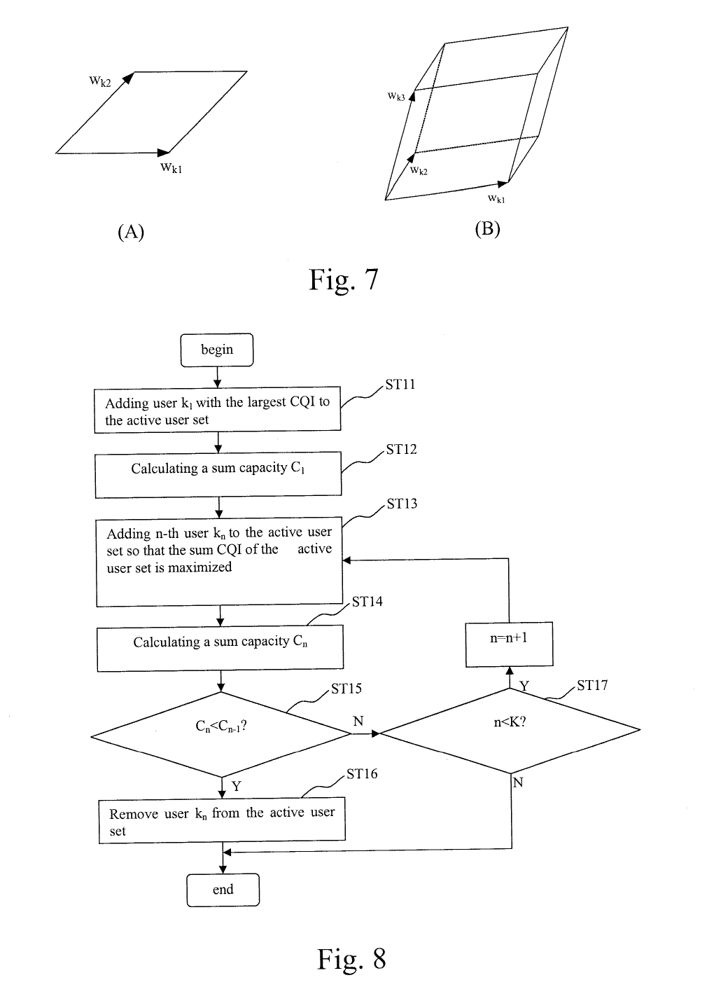

As shown in FIG. 7(A), in case of 2 users (k₁, k₂), the polyhedron is reduced to a quadrangle, and Volume(Q) can be calculated as the area of the quadrangle, i.e.,

$$‖ {w}_{{k}_{1}} ‖ \cdot ‖ {P}_{{w}_{{k}_{1}}}^{⊥} {w}_{{k}_{2}} ‖ ,$$

as shown in formulas 9 and 10. In this case,

$$‖ {w}_{{k}_{1}} ‖ \cdot ‖ {P}_{{w}_{{k}_{1}}}^{⊥} {w}_{{k}_{2}} ‖ = 0$$

means codewords of users k₁, k₂ (Wₖ₁, Wₖ₂) are coincident, which is to be avoided. On the other hand,

$$‖ {w}_{{k}_{1}} ‖ \cdot ‖ {P}_{{w}_{{k}_{1}}}^{⊥} {w}_{{k}_{2}} ‖ = 1$$

means Wₖ₁. Wₖ₂ are orthogonal to each other, which is preferable.

As shown in FIG. 7(B), in case of 3 users (k₁, k₂, k₃), the polyhedron becomes a hexahedron, and Volume(Q) can be calculated as the volume of the hexahedron, i.e.,

$$‖ {w}_{{k}_{1}} ‖ \cdot ‖ {P}_{{w}_{{k}_{1}}}^{⊥} {w}_{{k}_{2}} ‖ \cdot ‖ {P}_{[ {w}_{{k}_{1}} , {w}_{k 2} ]}^{⊥} {w}_{{k}_{3}} ‖ ,$$

as shown in formulas 13 and 14. In case of

$$‖ {w}_{{k}_{1}} ‖ \cdot ‖ {P}_{{w}_{{k}_{1}}}^{⊥} {w}_{{k}_{z}} ‖ \cdot ‖ {P}_{[ {w}_{{k}_{1}} , {w}_{k 2} ]}^{⊥} {w}_{{k}_{3}} ‖ = 0 ,$$

three codewords (Wₖ₁, Wₖ₂, Wₖ₃) cannot consititue a hexahedron, which means there are at least 2 codewords in the codeword set are coincident. On the other hand,

$$‖ {w}_{{k}_{1}} ‖ \cdot ‖ {P}_{{w}_{{k}_{1}}}^{⊥} {w}_{{k}_{2}} ‖ \cdot ‖ {P}_{[ {w}_{{k}_{1}} , {w}_{k 2} ]}^{⊥} {w}_{{k}_{3}} ‖ = 1$$

means Wₖ₁, Wₖ₂ and Wₖ₃ are orthogonal to each other, and do not exert interference to each other, which is preferable.

In case of more than 3 users, the codewords constitute a super-polyhedron, volume of this super-polyhedron Volume(Q) can be calculated similarly as described above. Again, Volume(Q)=0 means there are least 2 codewords in the codeword set are coincident, and Volume(Q)=1 means all codewords in the set are orthogonal to each other.

By introducing this term Volume(Q), the orthogonality among codewords is taken into consideration in calculation of sum CQI and sum capacity of the active user set. Therefore, the sum CQI and sum capacity of the active user set are calculated more precisely.

As described above, the schedule unit 35 of the base station determines the active user set S_{active}=[k₁, . . . ,k_{Q}], then the base station performs downlink beamforming for transmitting data of the users.

Basically, there are two kinds of beamforming for downlink transmission:

1. PVI Beamforming

The base station directly apply the precoding vector in codebook which is fed back by user equipments, i.e., the used transmit beamforming weight vₖ_{_{q}}=wₖ_{_{q}}, the transmitting signal y(t) at base station is denoted by,

$$y ( t ) = {\sum }_{q = 1}^{Q} \frac{P}{Q} {v}_{{k}_{q}} {s}_{{k}_{q}} \qquad ( 18 )$$

2. Zero-Forcing Beamforming

The base station determines transmit beamforming weight by zero-forcing pre-processing, in which the weight applied to k_{q}-th user vₖ_{_{q}} is the q-th column of the following matrix,

Z=[wₖ_{₁}, . . . wₖ_{_{Q}}]*([wₖ_{₁}, . . . wₖ_{_{Q}}]^{II}[wₖ_{₁}, . . . wₖ_{_{Q}}])⁻¹*[wₖ_{₁}, . . . wₖ_{_{Q}}] (19)

According to the first embodiment of the invention, the user equipments feed back to the base station a PVI that results in the maximum SNR, and a CQI value corresponding to the PVI, the base station selects at least one user from the plural user equipments based on the PVIs and the CQI values fed back from the user equipments in a manner that an effective sum SNR of the system is maximized. With this configuration, users can be scheduled appropriately, so that efficiency of the system is optimized.

### Second Embodiment

In the first embodiment, the schedule unit 35 judges end of the iteration based on effective sum SNR of the active user set, while in the second embodiment, the schedule unit 35 determines the active user set based on the sum capacity.

The second embodiment will be described in detail as follows. The structure of the SU_MIMO communication system of the second embodiment is same as that of the first embodiment, and the difference of the second embodiment from the first embodiment resides in the schedule process of the schedule unit of the base station. In the following description, the reference numerals of the first embodiment are adopted, the descriptions of the same parts are omitted, and emphasis is laid on the different parts.

Same as the first embodiment, each user terminal estimates its own channel state information, then selects the best precoding vector in the N^{b}-bit set of codebook according to maximization of receive signal-to-noise ratio (SNR) and calculates the channel quality indicator (CQI) value, and feedback the individual selected precoding vector index and CQI value to the base station.

FIG. 8 shows a flowchart of the schedule process of the second embodiment.

As shown in FIG. 8, in ST21, the schedule 35 determines the largest CQI among the CQIs feedback from the user equipments, and adds the corresponding user k1 to the active user set.

In ST22, the schedule unit 35 calculates a capacity of the active user set including only user k1, which is denoted as C1.

In ST23, the schedule unit 35 adds a n-th (n>1) user kn to the active user set so that the sum CQI of the active user set is the maximum.

In ST24, the schedule unit 35 calculates an sum capacity of the active user set, which is denoted as Cn.

In ST25, the schedule unit 35 judges whether the sum capacity of the active user set containing n users (Cn) is smaller than the sum capacity of the active user set containing n−1 users (Cn−1).

If it is judged Cₙ<Cₙ₋₁, an active user set including n−1 users is preferable to an active user set including n users, the process enters into ST16, the schedule unit 35 remove the newly added user kₙ from the active user set, so that the active user set includes user k₁˜kₙ₋₁. Then the schedule process of the schedule unit 35 is end.

On the other hand, if it is judged in ST25 that Cₙ is not smaller than Cₙ₋₁, the process proceeds to ST27. In ST27, it is judged whether the number of users included in the active user set equals to K (the number of antennas of the base station, that is, the number of users allowed of simultaneous transmission). If it is judged that n<K, n is incremented, and the process is returned to ST23 to repeat the following steps. However, if it is judged in ST27 n is not smaller than K, in other words, n=K, the schedule process is ended, with the active user set including users 1˜n.

Now a specific example will be provided.

First, the schedule unit 35 chooses the first user k₁ with the largest CQI value for downlink transmission, i.e.,

$${k}_{1} = arg {max}_{j = 1 , … , K} ( {CQI}_{j} * ‖ {w}_{j} ‖ ) \qquad ( 20 )$$

the sum capacity C₁ of the active user set including only the first user k₁ is calculated as:

C₁=log 2(1+P*CQIₖ_{₁}/σₙ²) (21)

where P is the total transmits power, and σₙ is the noise power.

Next, the schedule unit 35 selects a second user k₂ based on the CQI values of each user, so that the sum CQI of the active user set including users k₁ and k₂ is the maximum, as indicated by the following formula,

$${k}_{2} = arg {max}_{j = 1 , … , K} ( ( {CQI}_{{k}_{1}} + {CQI}_{j} ) \cdot ‖ {w}_{{k}_{1}} ‖ \cdot ‖ {P}_{{w}_{{k}_{1}}}^{⊥} {w}_{j} ‖ ) \qquad ( 22 )$$

Assuming there is no power allocation between these two users. The sum capacity of the active user set including these two users (k₁, k₂) is calculates as,

$${C}_{2} = log 2 ( 1 + \frac{P / 2 * {‖ {H}_{{k}_{1}}^{H} {w}_{{k}_{1}} ‖}^{4}}{{σ}_{n}^{2} {‖ {H}_{{k}_{1}}^{H} {w}_{{k}_{1}} ‖}^{2} + P / 2 {‖ {( {H}_{{k}_{1}}^{H} {w}_{{k}_{1}} )}^{H} ( {H}_{{k}_{1}}^{H} {w}_{{k}_{2}} ) ‖}^{2}} ) + log 2 ( 1 + \frac{P / 2 * {‖ {H}_{{k}_{2}}^{H} {w}_{{k}_{2}} ‖}^{4}}{{σ}_{n}^{2} {‖ {H}_{{k}_{2}}^{H} {w}_{{k}_{2}} ‖}^{2} + P / 2 {‖ {( {H}_{{k}_{2}}^{H} {w}_{{k}_{2}} )}^{H} ( {H}_{k 2}^{H} {w}_{{k}_{1}} ) ‖}^{2}} ) \qquad ( 23 )$$

The schedule unit 35 judges whether the sum capacity C₂ is smaller than C₁. If C₂ is smaller than C₁, the schedule unit 35 determines that the scheduling process is competed, and the active user set contains only user k₁. On the other hand, if C₂ is not smaller than C₁ and K>2, the schedule unit 35 proceeds to selection of the third user.

Similarly, the schedule unit selects the third user k₃ for downlink transmission in a manner that sum CQI of the active user set including users k₁, k₂ and k₃ is maximized, as indicated by the following formula:

$${k}_{3} = arg {max}_{j = 1 , … , K} ( ( {CQI}_{{k}_{1}} + {CQI}_{{k}_{2}} + {CQI}_{j} ) \cdot ‖ {w}_{{k}_{1}} ‖ \cdot ‖ {P}_{{w}_{{k}_{1}}}^{⊥} {w}_{{k}_{2}} ‖ \cdot ‖ {P}_{[ {w}_{{k}_{1}} , {w}_{k 2} ]}^{⊥} {w}_{j} ‖ ) \qquad ( 24 )$$

the sum capacity of these three users is given by,

$${C}_{3} = log 2 ( 1 + \frac{P / 3 * {‖ {H}_{{k}_{1}}^{H} {w}_{{k}_{1}} ‖}^{4}}{\begin{matrix}\begin{matrix}{σ}_{n}^{2} {‖ {H}_{{k}_{1}}^{H} {w}_{{k}_{1}} ‖}^{2} + \\ P / 3 {‖ {( {H}_{{k}_{1}}^{H} {w}_{{k}_{1}} )}^{H} ( {H}_{{k}_{1}}^{H} {w}_{{k}_{2}} ) ‖}^{2} +\end{matrix} \\ P / 3 {‖ {( {H}_{{k}_{1}}^{H} {w}_{{k}_{1}} )}^{H} ( {H}_{{k}_{1}}^{H} {w}_{{k}_{3}} ) ‖}^{2}\end{matrix}} ) + log 2 ( 1 + \frac{P / 3 * {‖ {H}_{{k}_{2}}^{H} {w}_{{k}_{2}} ‖}^{4}}{\begin{matrix}\begin{matrix}{σ}_{n}^{2} {‖ {H}_{{k}_{2}}^{H} {w}_{{k}_{2}} ‖}^{2} + \\ P / 3 {‖ {( {H}_{{k}_{2}}^{H} {w}_{{k}_{2}} )}^{H} ( {H}_{{k}_{2}}^{H} {w}_{{k}_{1}} ) ‖}^{2} +\end{matrix} \\ P / 3 {‖ {( {H}_{{k}_{2}}^{H} {w}_{{k}_{2}} )}^{H} ( {H}_{{k}_{2}}^{H} {w}_{{k}_{3}} ) ‖}^{2}\end{matrix}} ) log 2 ( 1 + \frac{P / 3 * {‖ {H}_{{k}_{3}}^{H} {w}_{{k}_{3}} ‖}^{4}}{\begin{matrix}\begin{matrix}{σ}_{n}^{2} {‖ {H}_{{k}_{3}}^{H} {w}_{{k}_{3}} ‖}^{2} + \\ P / 3 {‖ {( {H}_{{k}_{3} {w}_{{k}_{3}}}^{H} )}^{H} ( {H}_{{k}_{3}}^{H} {w}_{{k}_{1}} ) ‖}^{2} +\end{matrix} \\ P / 3 {‖ {( {H}_{{k}_{3}}^{H} {w}_{{k}_{3}} )}^{H} ( {H}_{{k}_{3}}^{H} {w}_{{k}_{2}} ) ‖}^{2}\end{matrix}} ) \qquad ( 25 )$$

Then, the schedule unit 35 judges whether C₃ is smaller than C₂. If C₃ is smaller than C₂, the schedule unit 35 determines that the scheduling process is competed, and the active user set contains only users k₁ and k₂. On the other hand, if C₃ is not smaller than C₂ and K>3, the schedule unit 35 proceeds to selection of the 4th user.

As described above, in general sense, the Q-th user is selected by,

$${k}_{Q} = arg {max}_{j = 1 , … , K} ( ( {\sum }_{q = 1}^{Q - 1} {CQI}_{{k}_{q}} + {CQI}_{j} ) \cdot Volume ( Q ) ) \qquad ( 26 )$$

The corresponding sum capacity of these k_{Q} users can be calculated similarly to formula (25) and is denoted by C_{Q}.

After the Q-th user is determined, it is judged whether C_{Q}<C_{Q-1} occurs, if it is judged C_{Q}<C_{Q-1}, the schedule process is ended and the active user set includes users k₁˜k_{Q-1}, the sum capacity C_{Q-1}. On the other hand, if C_{Q}>C_{Q-1} and K>Q, it is proceeded to the selection of the (Q+1)-th user.

The followed process of the base station are the same as what described in the first embodiment, and detailed description is omitted here.

According to the second embodiment of the invention, the user equipments feed back to the base station a PVI that results in the maximum SNR, and a CQI value corresponding to the PVI, the base station selects at least one user from the plural user equipments based on the PVIs and the CQI values fed back from the user equipments in a manner that a sum capacity of the system is maximized. With this configuration, users can be scheduled appropriately, so that efficiency of the system is optimized.

### Other Embodiments

In the above described first and second embodiments, the communication system is exemplified as an OFDM wireless communication system. However, the present invention is not limited to OFDM system, rather, the invention is independent of the multiplexing scheme, and can be applied in any MIMO communication system.

In the above described first and second embodiments, the number of receiving antennas of the user equipment is exemplified as 1, however, the invention is independent of the number of receiving antennas of the user equipment, and the invention can be applied to user equipment having more than one receiving antennas.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for scheduling users in a multi user-multi input multi output (MU-MIMO) wireless communication system, wherein the MU-MIMO wireless communication system comprises at least one based station and at least one user equipment, the base station is capable of accommodating plural user equipments by precoding based on a codebook, the method comprising:
each of the plural user equipments
conducting a channel estimation based on a pilot signal transmitted from the base station, to obtain a channel information;
determining, based on the channel information, a codeword that results in the maximum signal-noise-ratio (SNR), and a channel quality indictor (CQI) value corresponding to the codeword; and
feeding back the codeword and the CQI value to the base station, and the base station
setting up an active user set that includes at least one user allowed of downlink transmission based on the codewords and the CQI values fed back from the user equipments, so that a predetermined performance metric of the system is maximized.

2. The method of claim 1, wherein the performance metric is an effective sum SNR of the active user set.

3. The method of claim 2, where the step of setting up further comprises:
a) adding an user with the largest CQI value to the active user set, and calculating a first effective sum SNR of the active user set;
b) adding an user to the active user set so that the active user set includes n users, and that the sum CQI value of the active user set is the maximum, and calculating a n-th effective sum SNR of the active user set, based on the codewords and CQI values fed back from the plural user equipment;
c) repeating step b) until the n-th effective sum SNR is less than the (n−1)-th effective sum SNR.

4. The method of claim 1, wherein the performance metric is a sum capacity of the active user set.

5. The method of claim 4, where the step of setting up further comprises:
a) adding an user with the largest CQI value to the active user set, and calculating a first sum capacity of the active user set;
b) adding an user to the active user set so that the active user set includes n users, and that the sum CQI value of the active user set is the maximum, and calculating a n-th sum capacity of the active user set, based on the codewords and CQI values fed back from the plural user equipment;
c) repeating step b) until the n-th sum capacity is less than the (n−1)-th sum capacity.

6. The method of claim 1, wherein the performance metric includes orthogonality among codewords for users in the active user set.

7. A multi user-multi input multi output (MU-MIMO) wireless communication system, wherein the MU-MIMO wireless communication system comprises at least one based station and at least one user equipment, the base station is capable of accommodating plural user equipments by precoding based on a codebook, wherein,
each of the plural user equipments comprises:
a channel estimation unit configured to conduct a channel estimation based on a pilot signal transmitted from the base station, to obtain a channel information;
a determination unit configured to determine, based on the channel information, a codeword that results in the maximum signal-noise-ratio (SNR), and a channel quality indictor (CQI) value corresponding to the codeword; and
a transmission unit configured to feed back the codeword and the CQI value to the base station, and
the base station comprises:
a schedule unit configured to set up an active user set that includes at least one user allowed of downlink transmission based on the codewords and the CQI values feedbacked from the user equipments, so that a predetermined performance metric of the system is maximized.

8. The MU-MIMO wireless communication system of claim 7, wherein the performance metric is an effective sum SNR of the active user set.

9. The MU-MIMO wireless communication system of claim 8, wherein the schedule unit is further configured to
a) add an user with the largest CQI value to the active user set, and calculate a first effective sum SNR of the active user set;
b) add an user to the active user set so that the active user set includes n users, and that the sum CQI value of the active user set is the maximum, and calculate a n-th effective sum SNR of the active user set, based on the codewords and CQI values fed back from the plural user equipment;
c) repeat b) until the n-th effective sum SNR is less than the (n−1)-th effective sum SNR.

10. The MU-MIMO wireless communication system of claim 7, wherein the performance metric is a sum capacity of the active user set.

11. The MU-MIMO wireless communication system of claim 10, wherein the schedule unit is further configured to
a) add an user with the largest CQI value to the active user set, and calculate a first sum capacity of the active user set;
b) add an user to the active user set so that the active user set includes n users, and that the sum CQI value of the active user set is the maximum, and calculate a n-th sum capacity of the active user set, based on the codewords and CQI values fed back from the plural user equipment;
c) repeat b) until the n-th sum capacity is less than the (n−1)-th sum capacity.

12. The MU-MIMO wireless communication system of claim 7, wherein the performance metric includes orthogonality among codewords for users in the active user set.

13. A base station in a multi user-multi input multi output (MU-MIMO) wireless communication system, wherein the base station is capable of accommodating plural user equipments by precoding based on codebook, each of the plural user equipments comprises a channel estimation unit configured to conduct a channel estimation based on a pilot signal transmitted from the base station, to obtain a channel information; a determination unit configured to determine, based on the channel information, a codeword that results in the maximum signal-noise-ratio (SNR), and a channel quality indictor (CQI) value corresponding to the codeword; and a feedback unit configured to feed back the codeword and the CQI value to the base station, the base station comprises:
a schedule unit configured to set up an active user set that includes at least one user allowed of downlink transmission, based on the codewords and the CQI values fed back from the user equipments, so that a predetermined performance metric of the system is the maximum.

14. The base station of claim 13, wherein the performance metric is an effective sum SNR of the active user set.

15. The base station of claim 14, wherein the schedule unit is further configured to
a) add an user with the largest CQI value to the active user set, and calculate a first effective sum SNR of the active user set;
b) add an user to the active user set so that the active user set includes n users, and that the sum CQI value of the active user set is the maximum, and calculate a n-th effective sum SNR of the active user set, based on the codewords and CQI values fed back from the plural user equipment;
c) repeat b) until the n-th effective sum SNR is less than the (n−1)-th effective sum SNR.

16. The base station of claim 13, wherein the performance metric is a sum capacity of the active user set.

17. The base station of claim 16, wherein the schedule unit is further configured to
a) add an user with the largest CQI value to the active user set, and calculate a first sum capacity of the active user set;
b) add an user to the active user set so that the active user set includes n users, and that the sum CQI value of the active user set is the maximum, and calculate a n-th sum capacity of the active user set, based on the codewords and CQI values fed back from the plural user equipment;
c) repeat b) until the n-th sum capacity is less than the (n−1)-th sum capacity.

18. The base station of claim 13, wherein the performance metric includes orthogonality among codewords for users in the active user set.
